(19) United States
(12) Patent Application Publication
(10) Pub. No.: US 2025/0286776 A1
(43) Pub. Date: Sep. 11, 2025

(54) DETNET YANG MODEL MAPPING TO 3GPP CONFIGURATION

(71) Applicant: Telefonaktiebolaget LM Ericsson (publ), Stockholm (SE)

(72) Inventors: György MIKLÓS, Pilisborosjenö (HU); Balázs VARGA, Budapest (HU); János FARKAS, Kecskemét (HU)

(21) Appl. No.: 18/861,910

(22) PCT Filed: Apr. 28, 2023
(86) PCT No.: PCT/EP2023/061238

§ 371 Date: Oct. 31, 2024

Related U.S. Application Data
(60) Provisional application No. 63/337,437, filed on May 2, 2022.

(51) Int. Cl. H04L 41/0803; H04W 28/02

(52) U.S. Cl. CPC H04L 41/0803; H04W 28/0268

(57) ABSTRACT

A method for configuration mapping in a communications network. The method includes transmitting from a controller entity to a first network node at least one first configuration parameter; mapping at the first network node the at least one first configuration parameter to at least one second configuration parameter; transmitting from the first network node to a second network node the at least one second configuration parameter; and initiating at the second network node modification actions in the communications network.

### TECHNICAL FIELD

The present invention generally relates to configuration mapping in mobile networks, and more specifically, the invention relates to configuration mapping from Deterministic Networks to 3GPP networks.

### BACKGROUND

Deterministic Networking (DetNet) is an initiative by the IETF DetNet Working Group to develop deterministic data paths for real-time applications that require extremely low data loss rates, minimal packet delay variation (jitter), and bounded latency. Examples of such applications include audio and video streaming, industrial automation, and vehicle control. The DetNet network is governed by a central controller known as the Controller Plane Function (CPF) or DetNet controller, which manages information about the DetNet flows and their requirements.

The integration of the 3GPP 5G System (5GS) into the DetNet architecture is an aspect addressed by 3GPP. The goal is to expose the 5G system as a DetNet node, as documented in 3GPP TR 23.700-46.

A significant challenge in current solutions is the lack of approaches to address the interworking between 5GS and DetNet networks. This limitation stems from the disjoint configuration domains of 5GS and DetNet, which prevent seamless interworking between both systems.

A problematic aspect of current solutions is the absence of methods to address the interworking between the 5GS and a DetNet network. This lack of interworking solutions creates a barrier to achieving seamless communication and integration between these two networks, which is essential for the efficient operation of real-time applications with stringent requirements for data loss rates, jitter, and latency.

A further problematic aspect is the disjoint nature of the configuration domains between 5GS and DetNet. These disjoint configurations create compatibility issues and hinder the ability of both systems to interwork effectively. As a result, it becomes challenging to establish a cohesive framework that enables the seamless exchange of information and management of network resources between the 5GS and DetNet systems.

### SUMMARY

An object of the invention is to enable the mapping or translation of configuration information in a communications network. The solution proposed herein enables to overcome the limitations imposed by disjoint configurations and to enable efficient interworking between 5G Systems and Deterministic Networking networks.

An aspect of the invention relates to a method performed by a controller entity for configuration mapping in a communications network. The method comprises transmitting from a controller entity to a first network node at least one first configuration parameter, particularly wherein the at least one first configuration parameter is mapped to at least one second configuration parameter. In some embodiments, the method further comprises receiving at the controller entity from the first network node success or failure information pertaining to the configuration parameters and/or the configuration mapping, particularly wherein the success or failure information is provided by means of status codes. In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain. In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service. In some embodiments, the at least one second configuration parameter is mapped on a per network node basis. In some embodiments, the at least one first configuration parameter is maximum latency, and the at least one second configuration parameter is a required delay. In some embodiments, the at least one first configuration parameter is maximum loss, and the at least one second configuration parameter is Packet Error Rate (PER). In some embodiments, the at least one first configuration parameter is interval information, and the at least one second configuration parameter is periodicity information. In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR). In some embodiments, the at least one first configuration parameter is any one of maximum latency variation, maximum consecutive loss tolerance, maximum disordering, a differentiated services code point value, minimum packets per interval, and minimum payload size. In some embodiments, the user session is a PDU session, the user terminal is a User Equipment (UE). In some embodiments, the controller entity is a DetNet controller, the first network node is a Time Sensitive communication Time Synchronization function (TSCTSF), the second network node is a Policy Control Function (PCF), and the third network node is a Session Management Function (SMF).

A further aspect of the invention relates to a method performed by a first network node for configuration mapping in a communications network. The method comprises receiving at a first network node from a controller entity at least one first configuration parameter; mapping at the first network node the at least one first configuration parameter to at least one second configuration parameter; and transmitting from the first network node to a second network node the at least one second configuration parameter. In some embodiments, the method further comprises receiving at the first network node from the second network node success or failure information pertaining to the configuration parameters and/or the configuration mapping, particularly wherein the success or failure information is provided by means of status codes; and transmitting from the first network node to the controller entity success or failure information pertaining to the configuration parameters and/or the configuration mapping, particularly wherein the success or failure information is provided by means of status codes. In some embodiments, the method further comprises determining at the first network node at least one user session that is affected by the at least one first configuration parameter; and providing from the first network node to the second network node information on how the at least one user session is to be modified. In some embodiments, the method further comprises determining at the first network node traffic flow information or flow direction information regarding whether the traffic flow is uplink traffic, downlink traffic, or user terminal to user terminal traffic; and providing from the first network node to the second network node the traffic flow information or flow direction information. In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain. In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service. In some embodiments, the at least one second configuration parameter is mapped on a per network node basis. In some embodiments, the at least one first configuration parameter is maximum latency, and the at least one second configuration parameter is a required delay. In some embodiments, the at least one first configuration parameter is maximum loss, and the at least one second configuration parameter is Packet Error Rate (PER). In some embodiments, the at least one first configuration parameter is interval information, and the at least one second configuration parameter is periodicity information. In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR). In some embodiments, the at least one first configuration parameter is any one of maximum latency variation, maximum consecutive loss tolerance, maximum disordering, a differentiated services code point value, minimum packets per interval, and minimum payload size. In some embodiments, the modification actions comprise transmitting the at least one second configuration parameter to a third network node. In some embodiments, the modification actions comprise modifying the Quality of Service in the communications network, particularly wherein modifying the Quality of Service comprises establishing new QoS flows or modifying existing QoS flows, and particularly wherein the modifications are carried out for a user session. In some embodiments, the user session is a PDU session, the user terminal is a User Equipment (UE). In some embodiments, the controller entity is a DetNet controller, the first network node is a Time Sensitive communication Time Synchronization function (TSCTSF), the second network node is a Policy Control Function (PCF), and the third network node is a Session Management Function (SMF).

A further aspect of the invention relates to a method performed by a second network node for configuration mapping in a communications network. The method comprises receiving at a second network node from a first network node at least one second configuration parameter, particularly wherein the at least one second configuration parameter is mapped from at least one first configuration parameter; and initiating at the second network node modification actions in the communications network. In some embodiments, the method further comprises transmitting from the second network node to the first network node success or failure information pertaining to the configuration parameters and/or the configuration mapping, particularly wherein the success or failure information is provided by means of status codes. In some embodiments, the method further comprises receiving at the second network node from the first network node information on how the at least one user session is to be modified. In some embodiments, the method further comprises receiving at the second network node from the first network node the traffic flow information or flow direction information. In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain. In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service. In some embodiments, the at least one second configuration parameter is mapped on a per network node basis. In some embodiments, the at least one first configuration parameter is maximum latency, and the at least one second configuration parameter is a required delay. In some embodiments, the at least one first configuration parameter is maximum loss, and the at least one second configuration parameter is Packet Error Rate (PER). In some embodiments, the at least one first configuration parameter is interval information, and the at least one second configuration parameter is periodicity information. In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR). In some embodiments, the at least one first configuration parameter is any one of maximum latency variation, maximum consecutive loss tolerance, maximum disordering, a differentiated services code point value, minimum packets per interval, and minimum payload size. In some embodiments, the modification actions comprise transmitting the at least one second configuration parameter to a third network node. In some embodiments, the modification actions comprise modifying the Quality of Service in the communications network, particularly wherein modifying the Quality of Service comprises establishing new QoS flows or modifying existing QoS flows, and particularly wherein the modifications are carried out for a user session. In some embodiments, the user session is a PDU session, the user terminal is a User Equipment (UE). In some embodiments, the controller entity is a DetNet controller, the first network node is a Time Sensitive communication Time Synchronization function (TSCTSF), the second network node is a Policy Control Function (PCF), and the third network node is a Session Management Function (SMF).

Other aspects of the invention relate to mobile network nodes, particularly a second network node (111, 900), a first network node (116, 800), a controller entity (700) configured to perform the respective methods as described herein. Other aspects of the invention relate to computer program and computer program products.

In some embodiments, the second network node is a Policy Control Function (PCF). In some embodiments, the first network node is a Time Sensitive communication Time Synchronization function (TSCTSF). In some embodiments, the controller entity is a DetNet controller (DetNet controller).

Advantageously, the 5GS may act as a node in the DetNet system, making it possible to apply 5GS for deterministic IP based networking.

Additional objectives, features and advantages of the concepts disclosed herein will be apparent from the following description, claims and drawings, or may be learned by practice of the described technologies and concepts as set forth herein.

Generally, all terms used in the claims are to be interpreted according to their ordinary meaning in the technical field, unless explicitly defined otherwise herein. All references to ““a/an/the element, apparatus, component, means, module, step, etc.”” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an example networked system in accordance with particular embodiments of the solution described herein;

FIG. 2 illustrates an example block diagram showing network entities in a mobile communications network according to particular embodiments of the solution described herein;

FIG. 3 illustrates an example signaling diagram showing a procedure according to particular embodiments of the solution described herein;

FIG. 4 illustrates an example flowchart showing a method performed by a mobile network node according to particular embodiments of the solution described herein;

FIG. 5 illustrates an example flowchart showing a method performed by a mobile network node according to particular embodiments of the solution described herein;

FIG. 6 illustrates an example flowchart showing a method performed by a mobile network node according to particular embodiments of the solution described herein;

FIG. 7 illustrates an example block diagram of a mobile network node configured in accordance with particular embodiments of the solution described herein;

FIG. 8 illustrates an example block diagram of a mobile network node configured in accordance with particular embodiments of the solution described herein;

FIG. 9 illustrates an example block diagram of a mobile network node configured in accordance with particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

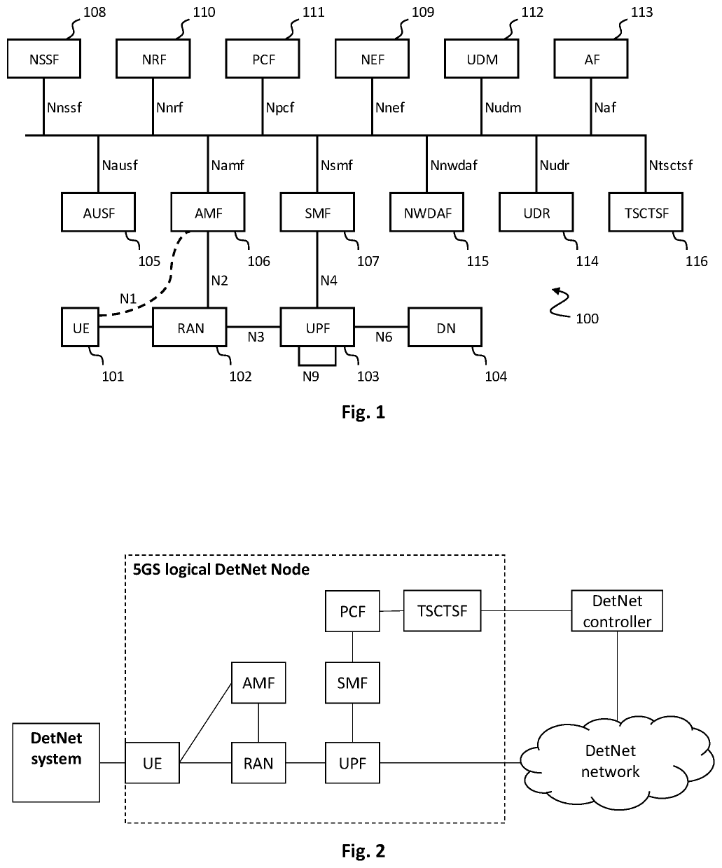

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, an AMF 106, SMF 107, UPF 103, PCF 111, AUSF 105, NRF 110, UDM 112, NEF 109, AF 113, and NSSF 108 are each considered to be an NF. One or more additional instances of the network functions (NF) may be incorporated into the networked system.

The solution described herein aims to enable the 5GS to map the configuration provided by a DetNet controller to 3GPP configuration.

A possible architecture for integration of the 5GS into a DetNet network is shown in FIG. 2. FIG. 2 illustrates the DetNet controller that is in control of the DetNet network, and the 5GS as a logical DetNet node (on a per UPF granularity). In the control plane, the TSCTSF function represents the DetNet node.

The TSCTSF uses the DetNet incoming and outgoing interfaces determine the flow direction and the PDU Session that is affected by the DetNet flow. The TSCTSF maps the DetNet flow requirements and flow specification to 3GPP QOS parameters.

The solution may comprise the following aspects:
The TSCTSF derives the required 5GS delay from the end to end delay based on configuration, e.g., take a given fraction of the end to end requirements and/or subtract a constant that corresponds to the rest of the network.
The DetNet controller adds a new parameter for the delay required in the 5GS, in addition to the end to end delay.
The TSCTSF calculates the required bandwidth based on the maximum packet length, maximum number of packets per interval, and the time needed to deliver the packets, which can be the traffic interval or a shorter value based on configuration.
The DSCP value in the flow specification is provided to the PCF and considered in the 3GPP QoS mapping.

In the proposed solution, on the device side, an end host as a DetNet system may make use of the DetNet functionality. The end host does not have to be DetNet aware.

The main principles of the solution may further comprise:
In the DetNet YANG model, a forwarding sub-layer configuration and a traffic profile may be used for the mapping.
The forwarding sub-layer configuration identifies the flow and the incoming, outgoing interfaces. Based on this information, the PDU Session and the flow direction (uplink, downlink or whether it is UE to UE) can be determined.
The DetNet traffic requirements in the traffic profile include the max-latency and the max-loss, which can be converted to the 3GPP delay and PER requirements.
With regards to the YANG model, the TSCTSF may either derive the per 5GS requirements from the end to end requirements, or the DetNet YANG model is extended for the 5GS to include also the requirements specific to the 5GS.
The DetNet traffic specification is used to determine the periodicity and the bandwidth requirement of the flow.

The DetNet YANG model outlines the parameters required for DetNet node configuration. The 5GS focuses on the forwarding sub-layer configuration and the Traffic Profile, which includes traffic requirements and specifications. The DetNet YANG model may contain traffic requirements that can be mapped to 3GPP parameters, such as max-latency (required delay) and max-loss (PER).

The traffic specification may include parameters like interval (periodicity) and max-pkts-per-interval/max-payload-size (maximum burst size), which can be used to calculate required bandwidth (GFBR and MFBR).

The TSCTSF may use the interval to generate the periodicity value in the TSCAI. However, the current DetNet YANG model only includes end-to-end traffic requirements, not per node requirements. Two main options for the 5GS acting as a DetNet node are (1) the TSCTSF derives per node traffic requirements from end-to-end traffic requirements using a pre-configured mapping based on deployment knowledge; (2) extend the IETF YANG model with additional parameters for the 5GS system on a per node basis. This can be achieved by a defined YANG model that imports a DetNet YANG model and adds necessary per node parameters.

The TSCTSF may obtain the DetNet YANG forwarding configuration, which includes incoming and outgoing interfaces. These interfaces are identified based on the reporting from the 5GS to the DetNet controller. The interface name is derived from the if-Index, which is based on the port number set by the UPF. The TSCTSF stores the mapping between the port number (if-Index and corresponding interface name) and the PDU Session, enabling PDU Session identification. The incoming and outgoing interfaces also determine the flow direction (uplink/downlink and UE to UE).

The TSCTSF may verify if the 3GPP system routes the given flow according to the DetNet forwarding sub-layer. The TSCTSF may accept or reject a DetNet configuration based on optional verification. For UE to UE flows, if allowed, the TSCTSF may generate separate requests for uplink and downlink legs.

The PCF may receive DetNet parameters from the TSCTSF and flow identification determined by the DetNet configuration, which is mapped to the flow description sent to the PCF. The flow description may be extended to accommodate DetNet needs, including the DSCP value and, optionally, IPv6 flow label and IPsec SPI. The PCF determines the parameters based on DetNet parameters, and may establish or modify QoS flows as needed.

Advantageously, the 5GS may act as a node in the DetNet system, making it possible to apply 5GS for deterministic IP based networking.

Further advantageously, the proposed solution does not require an NEF between the DetNet controller and the TSCTSF, since the DetNet controller is assumed to be trusted by the operator and can influence the QoS of the traffic flows.

This disclosure provides a method for configuration mapping in a communications network. The method comprises transmitting from a controller entity to a first network node at least one first configuration parameter; mapping at the first network node the at least one first configuration parameter to at least one second configuration parameter; transmitting from the first network node to a second network node the at least one second configuration parameter; and initiating at the second network node modification actions in the communications network. In some embodiments, the method further comprises transmitting from the second network node to the first network node success or failure information pertaining to the configuration parameters and/or the configuration mapping, particularly wherein the success or failure information is provided by means of status codes; and transmitting from the first network node to the controller entity success or failure information pertaining to the configuration parameters and/or the configuration mapping, particularly wherein the success or failure information is provided by means of status codes. In some embodiments, the method further comprises determining at the first network node at least one user session that is affected by the at least one first configuration parameter; and providing from the first network node to the second network node information on how the at least one user session is to be modified. In some embodiments, the method further comprises determining at the first network node traffic flow information or flow direction information regarding whether the traffic flow is uplink traffic, downlink traffic, or user terminal to user terminal traffic; and providing from the first network node to the second network node the traffic flow information or flow direction information. In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain. In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service. In some embodiments, the at least one second configuration parameter is mapped on a per network node basis. In some embodiments, the at least one first configuration parameter is maximum latency, and the at least one second configuration parameter is a required delay. In some embodiments, the at least one first configuration parameter is maximum loss, and the at least one second configuration parameter is Packet Error Rate (PER). In some embodiments, the at least one first configuration parameter is interval information, and the at least one second configuration parameter is periodicity information. In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR). In some embodiments, the at least one first configuration parameter is any one of maximum latency variation, maximum consecutive loss tolerance, maximum disordering, a differentiated services code point value, minimum packets per interval, and minimum payload size. In some embodiments, the modification actions comprise transmitting the at least one second configuration parameter to a third network node. In some embodiments, the modification actions comprise modifying the Quality of Service in the communications network, particularly wherein modifying the Quality of Service comprises establishing new QoS flows or modifying existing QoS flows, and particularly wherein the modifications are carried out for a user session. In some embodiments, the user session is a PDU session, the user terminal is a User Equipment (UE). In some embodiments, the controller entity is a DetNet controller, the first network node is a Time Sensitive communication Time Synchronization function (TSCTSF), the second network node is a Policy Control Function (PCF), and the third network node is a Session Management Function (SMF).

The solution may comprise:
In the DetNet YANG model, the forwarding sub-layer configuration and the traffic profile are used for the mapping.
The forwarding sub-layer configuration identifies the flow and the incoming, outgoing interfaces. Based on this information, the PDU Session and the flow direction (uplink, downlink or whether it is UE to UE) can be determined.
The DetNet traffic requirements in the traffic profile include the max-latency and the max-loss, which can be converted to the 3GPP delay and PER requirements.
The YANG model as currently defined in IETF only includes the end to end traffic requirements. There are two options: the TSCTSF may either derive the per 5GS requirements from the end to end requirements, or the DetNet YANG model is extended for the 5GS to include also the requirements specific to the 5GS.
The DetNet traffic specification is used to determine the periodicity and the bandwidth requirement of the flow.
The DSCP value in the DetNet traffic specification can be used to provide the priority to the PCF.

In the following, parameters that may be transmitted from the DetNet controller are described.

The YANG model in IETF draft-ietf-detnet-yang describes the parameters that are used by the DetNet nodes to set up the configuration for DetNet. As the 5GS realizes the forwarding sub-layer, it is the forwarding sub-layer configuration that needs to be considered in the YANG model. In addition, the YANG configuration can provide the Traffic Profile that includes the traffic requirements and the traffic specification that could be used by the 5GS system.

The DetNet YANG model may contain the following parameters in the traffic requirements which can be mapped to 3GPP parameters.
Max-latency, which relates to the required delay in the 5GS.
Max-loss, which relates to the PER.

The DetNet YANG model may also contain other parameters which do not map directly to 3GPP parameters: max-latency-variation, max-consecutive-loss-tolerance, max-misordering. There is no straightforward 3GPP mapping for these parameters as their definition differs from the current 3GPP parameters. Nevertheless, these parameters may be forwarded by the TSCTSF to the PCF to take into consideration when 3GPP QoS parameters are set.

The flow specification in the DetNet configuration may also contain a DSCP value. That value may also be provided to the PCF, as an optional input to determine the QoS settings.

The traffic specification may include the following parameters that can be mapped:
Interval: this corresponds to the periodicity in the 3GPP system.
max-pkts-per-interval, max-payload-size: together with the interval parameter, the required average bandwidth can be calculated using these parameters, which corresponds to the GFBR and MFBR. It is possible to set both the GFBR and MFBR to the same value, or alternative ways of calculation are also possible. As another alternative, it is possible to reserve not the average bandwidth, but the actual bandwidth, a higher value to reflect the temporary burstiness of the traffic. For this, instead of the traffic periodicity, a mixed maximum value can be used for the time needed to deliver the traffic burst. This may also be determined based on the maximum delay that needs to be provided for the traffic.
The maximum burst size can be calculated from the max-pkts-per-interval multiplied by the max-payload-size.

The traffic specification may also contain min-pkts-per-interval, and min-payload-size. Nevertheless, these parameters can be forwarded to the PCF for consideration in the QoS mapping, or to verify whether these constraints are observed in the actual traffic.

The TSCTSF can use the Interval to generate the periodicity value in the TSCAI.

Regarding the traffic requirements, it must be noted that the current DetNet YANG model includes only the end to end traffic requirements (e.g., in terms of maximal latency), and not the per node requirements that need to be realized by a given node. Even though it is the per node requirements that matter for the configuration of a given node, that information is currently not included in the IETF model as of today.

Based on the current IETF YANG model as currently defined, two main options can be used by the 5GS acting as a DetNet node:
The TSCTSF derives the per node traffic requirements from the end to end traffic requirements using a pre-configured mapping in the TSCTSF, based on the knowledge of the given deployment. E.g., take a given fraction of the end to end requirements and/or subtract a constant that corresponds to the rest of the network.
Extend the IETF YANG model with additional parameters that apply to the 5GS system on a per node basis. The YANG modelling language allows for extensibility. That can be achieved by a 3GPP defined YANG model that imports the IETF defined DetNet YANG model and adds the needed per node parameters. In that way, the model used by 5GS remains compatible with IETF DetNet, but allows for the DetNet controller to provide the traffic requirements on a per node basis when the DetNet controller is prepared for this and when it is aware that the DetNet node is a 5GS. In the appendix below, an exemplary module is shown for extending the IETF DetNet YANG model with per node values for max-latency and max-loss for the 5GS system.

In the following, how the identification of the PDU Sessions is carried out is described.

The TSCTSF receives the DetNet YANG forwarding configuration, which refers to the incoming and outgoing interfaces. These are based on the interface identification that is provided in the reporting from the 5GS to the DetNet controller. The interface is identified by its name, which is derived from the if-Index, which in turn is based on the port number that is set by the UPF. The TSCTSF stores the mapping between the port number (if-Index and the corresponding interface name) and the PDU Session, hence the PDU Session can be identified. The incoming and outgoing interfaces also identify whether the flow is uplink or downlink, hence flow direction is known, and also whether it is a UE to UE flow.

The TSCTSF may also perform a verification whether the 3GPP system routes the given flow as defined in the DetNet forwarding sub-layer. It can be possible to verify in the TSCTSF whether the incoming and outgoing interfaces in the DetNet configuration correspond to a valid routing in the 3GPP system. As an example, the TSCTSF may verify whether the destination IP address in a downlink flow towards a given interface corresponding to a PDU Session is the same IP address that is assigned for the same PDU Session. As another example, the TSCTSF may be configured with the knowledge whether or not UE to UE routing is enabled or not. The TSCTSF may also verify other parameters of the configuration, and reject a request if the configuration is outside of the supported range, based on TSCTSF configuration. As a result of this optional verification, the TSCTSF may decide to accept or reject a given DetNet configuration.

In the case of a UE to UE flow, if the system allows for such traffic, the TSCTSF generates separate requests towards the PCF for the uplink and the downlink legs of the flow.

In the following, the configuration for DetNet is described.

The PCF receives the relevant DetNet parameters from the TSCTSF as well as the identification of the flow as determined by the DetNet configuration, which is mapped to the flow description that is sent to the PCF. The stage 3 definition of the flow description can be extended according to the needs of DetNet, also including the DSCP value and optionally IPv6 flow label and IPsec SPI. The PCF determines the 3GPP parameters based on the DetNet parameters. The PCF may also consider the DSCP value in the flow description. The PCF may establish new QoS flows or modify existing QoS flows as needed.

A Network Exposure Function (NEF) can sit between the DetNet controller and the TSCTSF, for example in case the DetNet controller is not trusted by the operator. In this case the NEF will act as an intermediary node for the messages transmitted from the DetNet controller to the TSCTSF and vice versa. Additionally, the NEF may perform any functionality of the DetNet controller or TSCTSF.

This disclosure also provides mobile network nodes, particularly a second network node (111, 900), a first network node (116, 800), a controller entity (, 700) configured to perform the respective methods as described herein. In some embodiments, the second network node is a Policy Control Function (PCF) 111. In some embodiments, the first network node is a Time Sensitive communication Time Synchronization function (TSCTSF) 116. In some embodiments, the controller entity is a DetNet controller (DetNet controller).

This disclosure also provides the corresponding computer program and computer program products comprising code, for example in the form of a computer program, that when run on processing circuitry of the mobile network nodes causes the mobile network nodes to perform the disclosed methods.

Hereinafter, drawings showing examples of embodiments of the solution are described in detail.

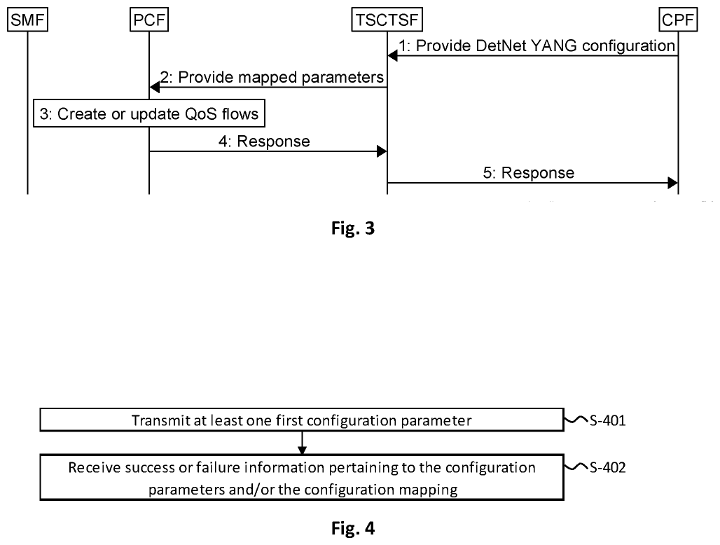

FIG. 3 is a signaling diagram illustrating a procedure for the mapping of the DetNet configuration. The procedure is performed by a DetNet controller, a TSCTSF, and PCF.

In step 1, the DetNet controller provides YANG configuration to the TSCTSF. The TSCTSF uses the identity of the incoming and outgoing interfaces to determine the affected PDU Session and whether the flow is uplink or downlink. The TSCTSF also determines if the flow is UE to UE in which case two PDU Sessions will be affected. The TSCTSF maps the configuration as described above and calculates the delay and PER requirements and the TSC Assistance Container.

In step 2, the TSCTSF provides the mapped parameters and the flow description to the PCF.

In step 3, the PCF determines, based on the parameters received from the TSCTSF, whether the existing QoS flows need to be modified or a new QoS flow needs to be created. Additionally, the TSC Assistance Container is provided to the SMF.

In step 4, the PCF responds to the TSCTSF, which includes information about the success of the configuration.

In step 5, the TSCTSF provides a response to the CPF regarding the result of the configuration setup. Optionally, it can be possible to provide 3GPP specific status codes to provide additional information if the requested configuration could not be set up.

Hereinafter, flowcharts showing examples of embodiments of the solution are described in detail. The embodiments correspond to methods performed by and involving a second network node (111, 900), a first network node (116, 800), a controller entity (, 700).

FIG. 4 is a flowchart illustrating a method performed by the controller entity for configuration mapping in a communications network.

In step S-401, the controller entity transmits to a first network node at least one first configuration parameter, particularly wherein the at least one first configuration parameter is mapped to at least one second configuration parameter.

In step S-402, the controller entity receives from the first network node success or failure information pertaining to the configuration parameters and/or the configuration mapping, particularly wherein the success or failure information is provided by means of status codes.

In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain.

In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service.

In some embodiments, the at least one second configuration parameter is mapped on a per network node basis.

In some embodiments, the at least one first configuration parameter is maximum latency, and the at least one second configuration parameter is a required delay.

In some embodiments, the at least one first configuration parameter is maximum loss, and the at least one second configuration parameter is Packet Error Rate (PER).

In some embodiments, the at least one first configuration parameter is interval information, and the at least one second configuration parameter is periodicity information.

In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR).

In some embodiments, the at least one first configuration parameter is any one of maximum latency variation, maximum consecutive loss tolerance, maximum disordering, a differentiated services code point value, minimum packets per interval, and minimum payload size.

In some embodiments, the user session is a PDU session, the user terminal is a User Equipment (UE).

In some embodiments, the controller entity is a DetNet controller, the first network node is a Time Sensitive communication Time Synchronization function (TSCTSF), the second network node is a Policy Control Function (PCF), and the third network node is a Session Management Function (SMF).

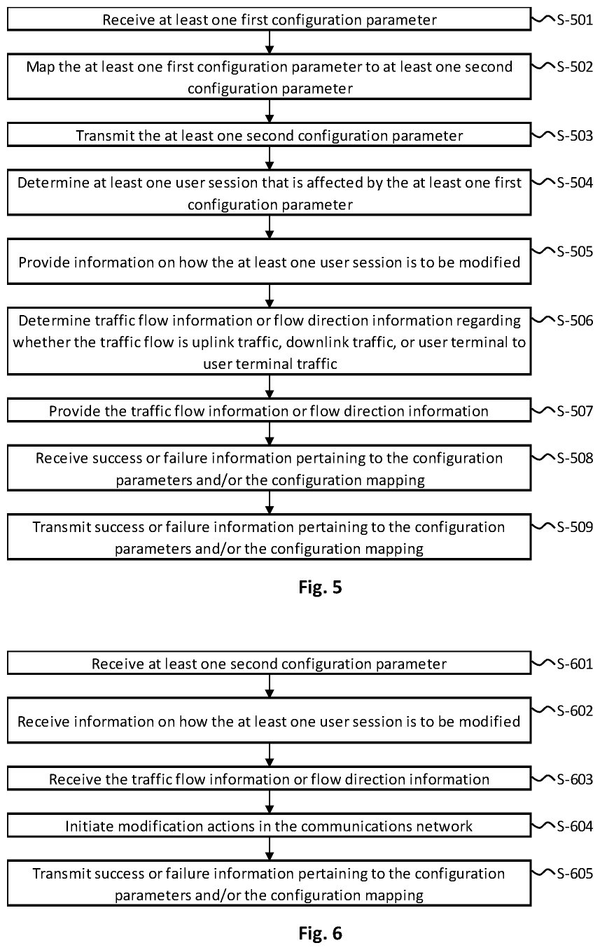

FIG. 5 is a flowchart illustrating a method performed by the first network node for configuration mapping in a communications network.

In step S-501, the first network node receives from a controller entity at least one first configuration parameter.

In step S-502, the first network node maps the at least one first configuration parameter to at least one second configuration parameter.

In step S-503, the first network node transmits to a second network node the at least one second configuration parameter.

In step S-504, the first network node determines at least one user session that is affected by the at least one first configuration parameter.

In step S-505, the first network node provides to the second network node information on how the at least one user session is to be modified.

In step S-506, the first network node determines traffic flow information or flow direction information regarding whether the traffic flow is uplink traffic, downlink traffic, or user terminal to user terminal traffic.

In step S-507, the first network node provides to the second network node the traffic flow information or flow direction information.

In step S-508, the first network node receives from the second network node success or failure information pertaining to the configuration parameters and/or the configuration mapping, particularly wherein the success or failure information is provided by means of status codes.

In step S-509, the first network node transmits to the controller entity success or failure information pertaining to the configuration parameters and/or the configuration mapping, particularly wherein the success or failure information is provided by means of status codes.

In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain.

In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service.

In some embodiments, the at least one second configuration parameter is mapped on a per network node basis.

In some embodiments, the at least one first configuration parameter is maximum latency, and the at least one second configuration parameter is a required delay.

In some embodiments, the at least one first configuration parameter is maximum loss, and the at least one second configuration parameter is Packet Error Rate (PER).

In some embodiments, the at least one first configuration parameter is interval information, and the at least one second configuration parameter is periodicity information.

In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR).

In some embodiments, the at least one first configuration parameter is any one of maximum latency variation, maximum consecutive loss tolerance, maximum disordering, a differentiated services code point value, minimum packets per interval, and minimum payload size.

In some embodiments, the modification actions comprise transmitting the at least one second configuration parameter to a third network node.

In some embodiments, the modification actions comprise modifying the Quality of Service in the communications network, particularly wherein modifying the Quality of Service comprises establishing new QoS flows or modifying existing QoS flows, and particularly wherein the modifications are carried out for a user session.

In some embodiments, the user session is a PDU session, the user terminal is a User Equipment (UE).

In some embodiments, the controller entity is a DetNet controller, the first network node is a Time Sensitive communication Time Synchronization function (TSCTSF), the second network node is a Policy Control Function (PCF), and the third network node is a Session Management Function (SMF).

FIG. 6 is a flowchart illustrating a method performed by the second network node for configuration mapping in a communications network.

In step S-601, the second network node receives from a first network node at least one second configuration parameter, particularly wherein the at least one second configuration parameter is mapped from at least one first configuration parameter.

In step S-602, the second network node receives from the first network node information on how the at least one user session is to be modified.

In step S-603, the second network node receives from the first network node the traffic flow information or flow direction information.

In step S-604, the second network node initiates modification actions in the communications network.

In step S-605, the second network node transmits to the first network node success or failure information pertaining to the configuration parameters and/or the configuration mapping, particularly wherein the success or failure information is provided by means of status codes.

In some embodiments, the at least one first configuration parameter pertains to the domain of the controller entity and the at least one second configuration parameter pertains to the domain of the communications network, particularly wherein the domain of the controller entity is Deterministic Networking (DetNet), and the domain of the communications network is the 3GPP domain.

In some embodiments, the at least one first configuration parameter pertains to a YANG model and the at least one second configuration parameter pertains to a 3GPP model, particularly wherein the YANG model is a DetNet YANG model and the 3GPP model pertains to 3GPP Quality of Service.

In some embodiments, the at least one second configuration parameter is mapped on a per network node basis.

In some embodiments, the at least one first configuration parameter is maximum latency, and the at least one second configuration parameter is a required delay.

In some embodiments, the at least one first configuration parameter is maximum loss, and the at least one second configuration parameter is Packet Error Rate (PER).

In some embodiments, the at least one first configuration parameter is interval information, and the at least one second configuration parameter is periodicity information.

In some embodiments, the at least one first configuration parameter is maximum packets per interval and/or maximum payload size, and the at least one second configuration parameter is Guaranteed Flow Bit Rate (GFBR) and/or Maximum Flow Bit Rate (MFBR).

In some embodiments, the at least one first configuration parameter is any one of maximum latency variation, maximum consecutive loss tolerance, maximum disordering, a differentiated services code point value, minimum packets per interval, and minimum payload size.

In some embodiments, the modification actions comprise transmitting the at least one second configuration parameter to a third network node.

In some embodiments, the modification actions comprise modifying the Quality of Service in the communications network, particularly wherein modifying the Quality of Service comprises establishing new QoS flows or modifying existing QoS flows, and particularly wherein the modifications are carried out for a user session.

In some embodiments, the user session is a PDU session, the user terminal is a User Equipment (UE).

In some embodiments, the controller entity is a DetNet controller, the first network node is a Time Sensitive communication Time Synchronization function (TSCTSF), the second network node is a Policy Control Function (PCF), and the third network node is a Session Management Function (SMF).

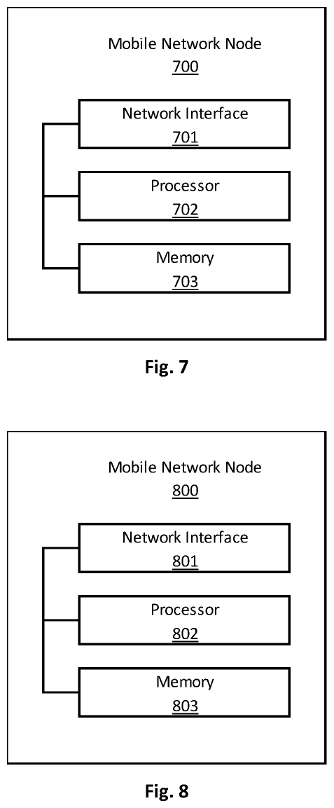

FIG. 7 is a block diagram illustrating elements of a mobile network node 700 of a mobile communications network. In some embodiments, the mobile network node 700 is a DetNet controller. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

FIG. 8 is a block diagram illustrating elements of a mobile network node 800 of a mobile communications network. In some embodiments, the mobile network node 800 is a TSCTSF 116. As shown, the mobile network node may include network interface circuitry 801 (also referred to as a network interface) configured to provide communications with other nodes of the core network and/or the network. The mobile network node may also include a processing circuitry 802 (also referred to as a processor) coupled to the network interface circuitry, and memory circuitry 803 (also referred to as memory) coupled to the processing circuitry. The memory circuitry 803 may include computer readable program code that when executed by the processing circuitry 802 causes the processing circuitry to perform operations according to embodiments disclosed herein. According to other embodiments, processing circuitry 802 may be defined to include memory so that a separate memory circuitry is not required. As discussed herein, operations of the mobile network node may be performed by processing circuitry 802 and/or network interface circuitry 801. For example, processing circuitry 802 may control network interface circuitry 801 to transmit communications through network interface circuitry 801 to one or more other network nodes and/or to receive communications through network interface circuitry from one or more other network nodes. Moreover, modules may be stored in memory 803, and these modules may provide instructions so that when instructions of a module are executed by processing circuitry 802, processing circuitry 802 performs respective operations (e.g., operations discussed below with respect to Example Embodiments relating to core network nodes).

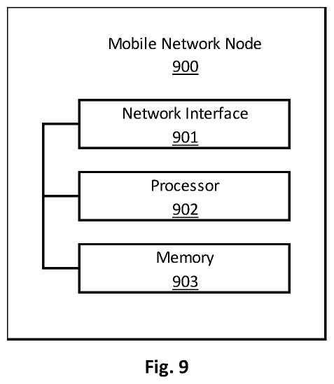

FIG. 9 is a block diagram illustrating elements of a mobile network node 900 of a mobile communications network. In some embodiments, the mobile network node 900 is a PCF 111. As shown, the mobile network node may include network interface circuitry 901 (also referred to as a network interface) configured to provide communications with other nodes of the core network and/or the network. The mobile network node may also include a processing circuitry 902 (also referred to as a processor) coupled to the network interface circuitry, and memory circuitry 903 (also referred to as memory) coupled to the processing circuitry. The memory circuitry 903 may include computer readable program code that when executed by the processing circuitry 902 causes the processing circuitry to perform operations according to embodiments disclosed herein. According to other embodiments, processing circuitry 902 may be defined to include memory so that a separate memory circuitry is not required. As discussed herein, operations of the mobile network node may be performed by processing circuitry 902 and/or network interface circuitry 901. For example, processing circuitry 902 may control network interface circuitry 901 to transmit communications through network interface circuitry 901 to one or more other network nodes and/or to receive communications through network interface circuitry from one or more other network nodes. Moreover, modules may be stored in memory 903, and these modules may provide instructions so that when instructions of a module are executed by processing circuitry 902, processing circuitry 902 performs respective operations (e.g., operations discussed below with respect to Example Embodiments relating to core network nodes).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof.

### ABBREVIATIONS

AF Application Function

AMF Access and Mobility Function

AS Application Server

BAT Burst Arrival Time

CN Core Network

CNC Central Network Controller

CUC Central User Controller

DetNet Deterministic Networking

DSCP Differentiated Services Code Point

DNN Data Network Name

DS-TT Device Side TSN Translator

EPC Evolved Packet Core

GPSI Generic Public Subscription Identifier

IGP Interior Gateway Protocol

LLDP Link Layer Discovery Protocol

MAC Medium Access Control

ND Neighbor Discovery

NEF Network Exposure Function

NRF Network Resource Function

NW-TT Network Side TSN Translator

PDB Packet Delay Budget

PCF Policy Control Function

PSA PDU Session Anchor

QFI QoS Flow Identifier

PMIC Port Management Information Container

RAN Radio Access Network

SDN Software Defined Network

SMF Session Management Function

S-NSSAI Single Network Slice Selection Assistance Information

SSC Session and Service Continuity

SUPI Subscription Permanent Identifier

SW Switch

TSC Time Sensitive Communication

TSCAI Time Sensitive Communication Assistance Information

TSN Time-Sensitive Networking

UDM User Data Management

UE User Equipment

UMIC User Plane Node Management Information Container

UPF User Plane Function

VLAN Virtual Local Area Network

1.-16. (canceled)

17. A method performed by a controller entity for configuration mapping in a communications network, the method comprising:
transmitting to a first network node at least one first configuration parameter, the at least one first configuration parameter being mapped to at least one second configuration parameter; and
receiving from the first network node success or failure information pertaining to one or both of the configuration parameters and the configuration mapping, the success or failure information being provided by status codes.

18. (canceled)

19. The method of claim 17, wherein the at least one first configuration parameter pertains to the domain of the controller entity and the at least one second configuration parameter pertains to the domain of the communications network, particularly wherein the domain of the controller entity is Deterministic Networking, DetNet, and the domain of the communications network is the 3GPP domain.

20. (canceled)

21. (canceled)

22. The method of claim 17, wherein the at least one first configuration parameter is maximum latency, and the at least one second configuration parameter is a required delay; or
wherein the at least one first configuration parameter is maximum loss, and the at least one second configuration parameter is Packet Error Rate, PER; or
wherein the at least one first configuration parameter is interval information, and the at least one second configuration parameter is periodicity information; or
wherein the at least one first configuration parameter is one or both maximum packets per interval and maximum payload size, and the at least one second configuration parameter is one or more of Guaranteed Flow Bit Rate, GFBR, and Maximum Flow Bit Rate, MFBR.

23. (canceled)

24. (canceled)

25. (canceled)

26. The method of claim 17, wherein the at least one first configuration parameter is any one of maximum latency variation, maximum consecutive loss tolerance, maximum disordering, a differentiated services code point value, minimum packets per interval, and minimum payload size.

27. (canceled)

28. The method of claim 17, wherein the controller entity is a DetNet controller and the first network node is a Time Sensitive communication Time Synchronization function, TSCTSF.

29. A method performed by a first network node for configuration mapping in a communications network, the method comprising:
receiving from a controller entity at least one first configuration parameter;
mapping the at least one first configuration parameter to at least one second configuration parameter;
transmitting to a second network node the at least one second configuration parameter;
receiving from the second network node success or failure information pertaining to one or both of the configuration parameters and the configuration mapping, the success or failure information being provided by status codes; and
transmitting to the controller entity success or failure information pertaining to the one of both of the configuration parameters and the configuration mapping, the success or failure information being provided by status codes.

30. (canceled)

31. The method of claim 29, further comprising:
determining at least one user session that is affected by the at least one first configuration parameter; and
providing to the second network node information on how the at least one user session is to be modified.

32. The method of claim 29, further comprising:
determining traffic flow information or flow direction information regarding whether the traffic flow is uplink traffic, downlink traffic, or user terminal to user terminal traffic; and
providing to the second network node the traffic flow information or flow direction information.

33.-35. (canceled)

36. The method of claim 29, wherein the at least one first configuration parameter is maximum latency, and the at least one second configuration parameter is a required delay; or
wherein the at least one first configuration parameter is maximum loss, and the at least one second configuration parameter is Packet Error Rate, PER; or
wherein the at least one first configuration parameter is interval information, and the at least one second configuration parameter is periodicity information; or
wherein the at least one first configuration parameter is one or both of maximum packets per interval and maximum payload size, and the at least one second configuration parameter is one or more of Guaranteed Flow Bit Rate, GFBR, and Maximum Flow Bit Rate, MFBR.

37. (canceled)

38. (canceled)

39. (canceled)

40. The method of claim 29, wherein the at least one first configuration parameter is any one of maximum latency variation, maximum consecutive loss tolerance, maximum disordering, a differentiated services code point value, minimum packets per interval, and minimum payload size.

41.-43. (canceled)

44. The method of claim 29, wherein the controller entity is a DetNet controller, the first network node is a Time Sensitive communication Time Synchronization function, TSCTSF, and the second network node is a Policy Control Function, PCF.

45. A method performed by a second network node for configuration mapping in a communications network, the method comprising:
receiving from a first network node at least one second configuration parameter, particularly wherein the at least one second configuration parameter is mapped from at least one first configuration parameter;
initiating modification actions in the communications network; and
transmitting to the first network node success or failure information pertaining to one or both of the configuration parameters and the configuration mapping, the success or failure information is provided by status codes.

46. (canceled)

47. The method of claim 45, further comprising:
receiving at the second network node from the first network node information on how the at least one user session is to be modified.

48. The method of claim 45, further comprising:
receiving at the second network node from the first network node the traffic flow information or flow direction information.

49.-51. (canceled)

52. The method of claim 45, wherein the at least one first configuration parameter is maximum latency, and the at least one second configuration parameter is a required delay; or
wherein the at least one first configuration parameter is maximum loss, and the at least one second configuration parameter is Packet Error Rate, PER; or
wherein the at least one first configuration parameter is interval information, and the at least one second configuration parameter is periodicity information; or
wherein the at least one first configuration parameter is maximum packets per interval and/or maximum payload size, and the at least one second configuration parameter is Guaranteed Flow Bit Rate, GFBR, and/or Maximum Flow Bit Rate, MFBR.

53.-55. (canceled)

56. The method of claim 45, wherein the at least one first configuration parameter is any one of maximum latency variation, maximum consecutive loss tolerance, maximum disordering, a differentiated services code point value, minimum packets per interval, and minimum payload size.

57.-59. (canceled)

60. The method of claim 45, wherein the controller entity is a DetNet controller, the first network node is a Time Sensitive communication Time Synchronization function, TSCTSF, and the second network node is a Policy Control Function, PCF.

61. An apparatus for configuration mapping in a communications network, the apparatus comprising a processor and a memory, the memory containing instructions executable by the processor such that the apparatus is;
operable to:
transmit to a first network node at least one first configuration parameter, the at least one first configuration parameter being mapped to at least one second configuration parameter; and
receive from the first network node success or failure information pertaining to one or both of the configuration parameters and the configuration mapping, the success or failure information being provided by status codes; or
operable to:
receive from a controller entity at least one first configuration parameter;
map the at least one first configuration parameter to at least one second configuration parameter;
transmit to a second network node the at least one second configuration parameter;
receive from the second network node success or failure information pertaining to one or both of the configuration parameters and the configuration mapping, the success or failure information being provided by status codes; and
transmit to the controller entity success or failure information pertaining to the one of both of the configuration parameters and the configuration mapping, the success or failure information being provided by status codes; or
operable to:
receive from a first network node at least one second configuration parameter, particularly wherein the at least one second configuration parameter is mapped from at least one first configuration parameter;
initiate modification actions in the communications network; and
transmit to the first network node success or failure information pertaining to one or both of the configuration parameters and the configuration mapping, the success or failure information is provided by status codes.

62.-67. (canceled)

68. The method of claim 19, wherein the controller entity is a DetNet controller and the first network node is a Time Sensitive communication Time Synchronization function, TSCTSF.

69. The method of claim 40, wherein the controller entity is a DetNet controller, the first network node is a Time Sensitive communication Time Synchronization function, TSCTSF, and the second network node is a Policy Control Function, PCF.
